(19) United States
(12) Patent Application Publication
(10) Pub. No.: US 2024/0298572 A1
(43) Pub. Date: Sep. 12, 2024

(54) AGRICULTURAL HARVESTING MACHINE

(71) Applicant: CLAAS Saulgau GmbH, Bad Saulgau (DE)

(72) Inventors: Niklas Löffler, Hohentengen (DE); Tobias Deufel, Meßkirch-Menningen (DE); Benjamin Bauknecht, Ostrach (DE)

(73) Assignee: CLAAS Saulgau GmbH, Bad Saulgau (DE)

(21) Appl. No.: 18/597,038

(22) Filed: Mar. 6, 2024

(30) Foreign Application Priority Data
Mar. 7, 2023 (DE) 102023105635.2

(51) Int. Cl. A01D 43/08

(52) U.S. Cl. CPC A01D 43/087

(57) ABSTRACT

An agricultural harvesting machine with a transfer device is disclosed. The transfer device includes a first section and a second section, which pivots about a pivot axis relative to the first section between an unfolded position in which the second section extends as a longitudinal extension of the first section and a folded position in which the second section is positioned alongside the first section. A drive device includes a first piston/cylinder unit to drive a pivoting movement of the second section between the folded position and the unfolded position. A locking device includes a second piston/cylinder unit to lock the second section to the first section in the unfolded position. A piston of the second piston/cylinder unit, in a piston position, has a defined distance from a cylinder base of a cylinder of the second piston/cylinder unit, thereby causing the second section to lock in the unfolded position.

### CROSS REFERENCE TO RELATED APPLICATION

This application claims priority under 35 U.S.C. § 119 to German Patent Application No. DE 102023105635.2 (filed Mar. 7, 2023), the entire disclosure of each of which is hereby incorporated by reference herein in their entirety.

### TECHNICAL FIELD

The present invention relates to an agricultural harvesting machine and a method for operating an agricultural harvesting machine.

### BACKGROUND

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

DE 10 2014 115 503 A1 discloses an agricultural harvesting machine with a transfer device designed as a discharge chute, through which harvested material harvested by the agricultural harvesting machine may be conveyed by the agricultural harvester agricultural harvesting machine towards a transport vehicle. The transfer device has a first section and a second section that may be pivoted about a pivot axis relative to the first section. The second section may be pivoted relative to the first section about the pivot axis between an unfolded position and a folded position. In the unfolded position, the second section extends as a longitudinal extension of the first section. In the folded position, the second section is arranged or positioned alongside the first section. A drive device, which has a first piston/cylinder unit, serves to drive the pivoting movement of the second section relative to the first section between the folded position and the unfolded position. By means of a locking device, the second section may be locked on the first section in the unfolded position, wherein the locking device has a second piston/cylinder unit.

### BRIEF DESCRIPTION OF THE DRAWINGS

The present application is further described in the detailed description which follows, in reference to the noted drawings by way of non-limiting examples of exemplary embodiment, in which like reference numerals represent similar parts throughout the several views of the drawings, and wherein:

FIG. 1 illustrates a section of a transfer device of an agricultural harvesting machine according to the invention in a view of a first side of the transfer device;

FIG. 2 illustrates a section of the transfer device of the agricultural harvesting machine according to the invention in a view of a second side of the transfer device;

FIG. 3 illustrates another section of the transfer device of the agricultural harvesting machine according to the invention in a view of the second side of the transfer device; and

FIG. 4 illustrates hydraulic diagram of the transfer device of the agricultural harvesting machine according to the invention.

### DETAILED DESCRIPTION

As discussed in the background, DE 10 2014 115 503 A1 discloses an agricultural harvesting machine with a transfer device designed as a discharge chute with a first section and a second section. With such agricultural harvesting machines whose transfer device has a first section and a second section pivotable towards the first section, an undesirable relative movement between the two sections may occur when the second section is in the unfolded position even after locking the second section to the first section in the unfolded position. This may be caused, for example, by wear on a pivoting mechanism, by wear on the locking device, or the like. This may lead to disruptions in the harvested material flow within the transfer device.

Thus, in one or some embodiments, an agricultural harvesting machine is disclosed which is configured to avoid such disturbances in the harvested material flow within the transfer device.

In one or some embodiments, an agricultural harvesting machine is disclosed which includes a transfer device that has a first section and a second section, with the second section being pivoted about a pivot axis relative to the first section. In particular, the second section may pivot relative to the first section about the pivot axis between an unfolded position in which the second section extends as a longitudinal extension of the first section and a folded position in which the second section is arranged or positioned alongside the first section. The agricultural harvesting machine may further include: a drive device having a first piston/cylinder unit configured to drive a pivoting movement of the second section relative to the first section between the folded position and the unfolded position: and a locking device having a second piston/cylinder unit configured to lock the second section to the first section in the unfolded position. The second piston/cylinder unit may include at least one piston (e.g., a piston) and at least one cylinder (e.g., a cylinder), wherein the at least one piston has a defined distance from a cylinder base of the at least one cylinder of the second piston/cylinder unit in a piston position, thereby causing the second section to lock in the unfolded position. As a result, the piston of the second piston/cylinder unit (e.g., in the piston position) does not travel to stop on the cylinder (e.g., does not touch the cylinder in the piston position), and may thus cause the second section to lock in the unfolded position. This may make it possible to compensate for wear, for example of the folding mechanism or the locking device, and thus may ensure secure locking of the second section on the first section in the unfolded position (e.g., to avoid undesired relative movement between the two sections of the transfer device in the unfolded and locked position of the second section). This may ensure an undisturbed harvested material flow through the transfer device, such as at all times.

In one or some embodiments, the first piston/cylinder unit may be arranged or positioned on a first side of the transfer device, on which the pivot axis is formed, and the second piston/cylinder unit may be arranged or positioned on an opposite second side of the transfer device. This arrangement may be used in order to reliably lock the second section when the second section is in the unfolded position to the first section. A lever arm large relative to the pivot axis may therefore be used for the locking device.

In one or some embodiments, the locking device has a locking lever arranged or positioned on the second side of the transfer device, which may interact with the piston of the second piston/cylinder unit in such a way that the locking lever presses the first section and the second section, such as end regions of the first section and the second section, against each other when the second section is locked to the first section. In this way, the locking lever may press at least a part of the first section and the second section with each other when the second section is locked to the first section. In so doing, the second section may be actively pulled towards the first section by the locking device. This may also serve to provide an advantageous locking of the second section on the first section when the second section is in the unfolded position.

In one or some embodiments, the piston of the first piston/cylinder unit extends from the cylinder of the first piston/cylinder unit to transfer the second section into the unfolded position, wherein the piston of the second piston/cylinder unit retracts into the cylinder of the second piston/cylinder unit in the unfolded position to lock the second section to the first section.

The extension of the piston of the first piston/cylinder unit to transfer the second section into the unfolded position and the retraction of the piston of the second piston/cylinder unit to lock the second section to the first section in the unfolded position may be controlled by a sequence control. For this purpose, a sensor may be used to detect when the second section has reached the unfolded position, and the piston of the second piston/cylinder unit may then be retracted to lock it. This may be particularly preferable in order to ensure advantageous locking of the second section to the first section when the second section is in the unfolded position.

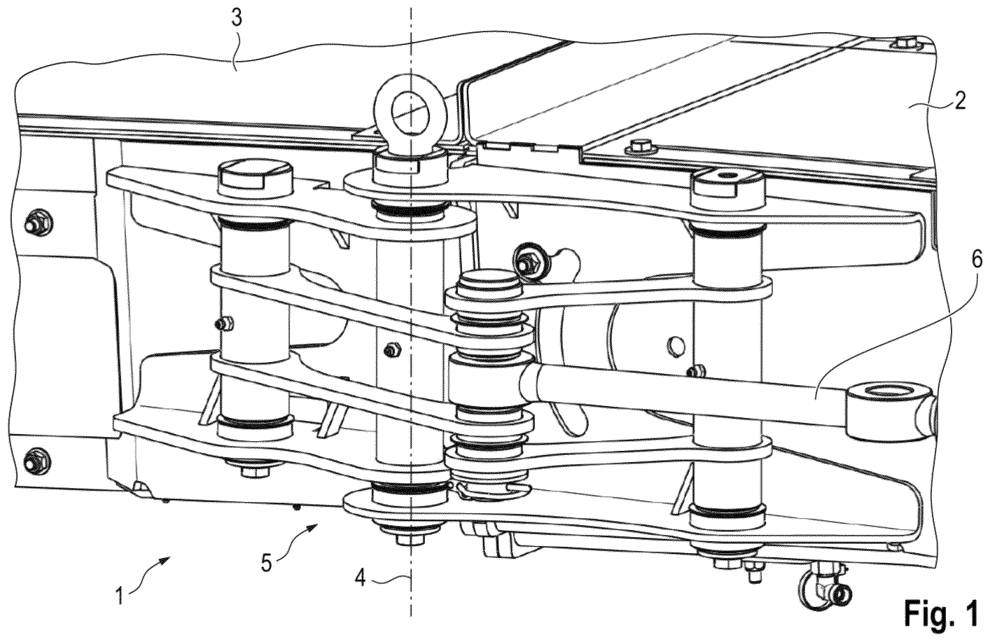

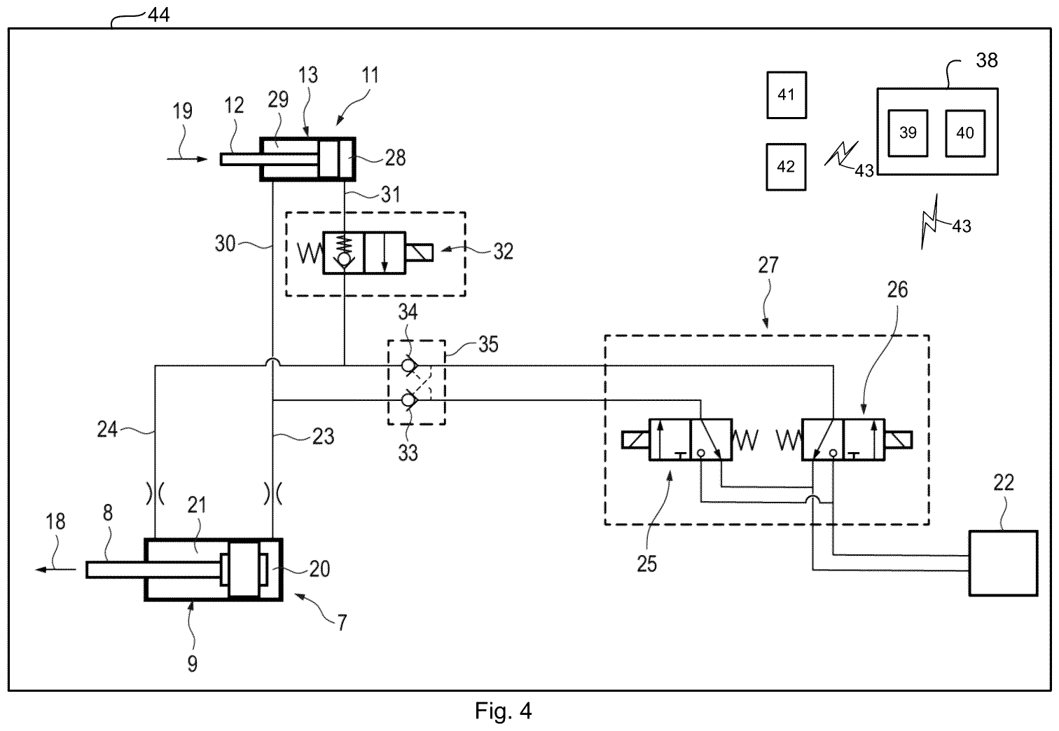

Referring to the figures, FIGS. 1 to 3 each illustrate a section of a transfer device 1 of an agricultural harvesting machine (see 44 in FIG. 4) designed as a discharge chute in different views. With the aid of such a transfer device, harvested material may be conveyed from the agricultural harvesting machine towards a transport vehicle.

FIGS. 1 to 3 show a first section 2 and a second section 3 of the transfer device 1. Examples of transfer devices are disclosed in US Patent Application Publication No. 2014/0325422 A1, U.S. Pat. Nos. 8,438,821 B2, 7,873,456 B2, and 7,537,519 B2, each of which are incorporated by reference herein in their entirety. The first section 2 may engage with a first, not shown end on a machine housing of the harvesting machine. Examples of harvesting machines are disclosed in US Patent Application Publication No. 2023/0065442 A1 and US Patent Application Publication No. 2022/0053692 A1, both of which are incorporated by reference herein in their entirety. An opposite second end of the first section 2 may be adjoined by the second section 3 of the transfer device, which may be displaced about a pivot axis 4 relative to the first section 2 between a folded position and an unfolded position. In the unfolded position, the second section 3 may extend as a longitudinal extension of the first section 2. In the folded position, the second section 3 may be arranged or positioned alongside the first section 2.

In one or some embodiments, the pivot axis 4, about which the second section 3 may be displaced relative to the first section 2 between the folded position and the unfolded position, is provided by a pivoting joint 5 which may be formed on a first side of the transfer device 1 in the region of opposite or adjacent ends of the first section 2 and the second section 3 of the transfer device 1.

FIG. 1 illustrates a view of this first side of the transfer device 1 on which the pivoting joint 5 providing the pivot axis 4 is formed. The pivoting joint 5 (which may be configured to pivot or swivel) may be coupled via a coupling rod 6 to a drive device, not shown in FIGS. 1 to 3, for driving the swivel movement between the first section 2 and the second section 3, wherein the first piston/cylinder unit 7 of this drive device is shown in the hydraulic diagram of agricultural harvesting machine 44 in FIG. 4. The first piston/cylinder unit 7 of the drive device, which may serve to drive the pivoting movement of the second section 3 relative to the first section 2 between the folded position and the unfolded position of the second section 3, provides a first piston/cylinder unit 7 of the transfer device 1, which may have a piston 8 and a cylinder 9. The piston 8 of the first piston/cylinder unit 7 of the drive device may interact with the coupling rod 6 of FIG. 1.

In order to lock the second section 3 in the unfolded position to the first section 2 when the second section 3 of the transfer device 1 is displaced relative to the first section thereof in the unfolded position, the transfer device 1 may also have a locking device 10.

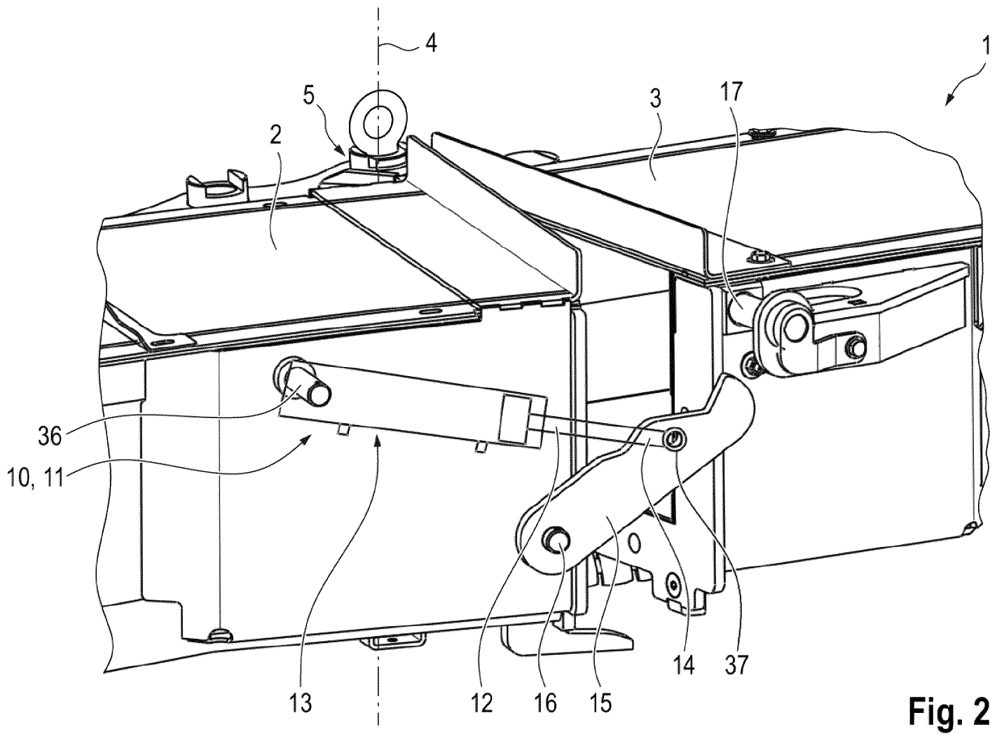

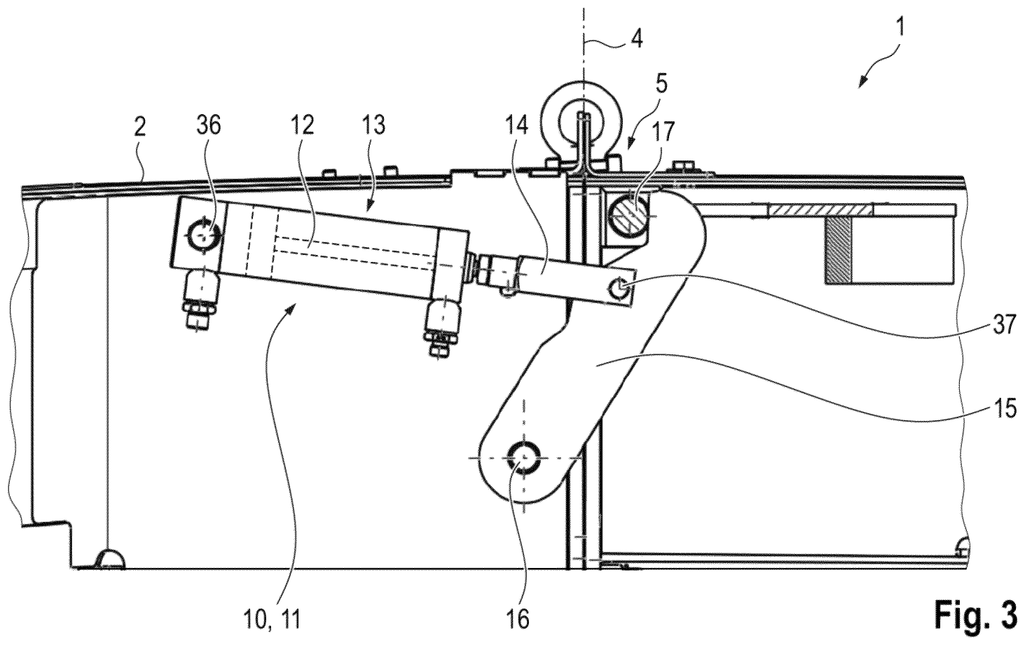

In the depicted embodiment, the locking device 10 is arranged or positioned on a second side of the transfer device 1 opposite the first side of the transfer device 1, wherein this second side is opposite the first side of the transfer device on which the pivot axis 4 and the pivoting joint 5 are formed. FIGS. 2 and 3 each show a view of this second side of the transfer device 1 on which the locking device 10 is formed.

If the first section 2 and the second section 3 are to be pivoted relative to each other, the locking device 10 may be unlocked and may release the relative movement of the second section 3 relative to the first section 2. If, on the other hand, the second section 3 is moved into the unfolded position in which the second section 3 extends as a longitudinal extension of the first section 2, the locking device 10 may be locked in order to lock the second section 3 in the unfolded position.

In one or some embodiments, the locking device 10 has a second piston/cylinder unit 11, which may be a part of the transfer device 1. The second piston/cylinder unit 11 may have a piston 12 and a cylinder 13. The second piston/cylinder unit 11 is shown in FIGS. 2 and 3 as well as in the hydraulic diagram in FIG. 4. FIG. 2 shows the locking device 10 in an unlocked state, in which the locking device 10 releases a swivel movement of the second section 3 relative to the first section 2. FIG. 3 shows the locking device 10 in a locked state in which the locking device 10 locks the second section 3 in the unfolded position to the first section 2.

In one or some embodiments, a coupling rod 14, which may engage with a locking lever 15 of the locking device 10, may interact with the piston 12 of the second piston/cylinder unit 11. In one or some embodiments, at a first end, the locking lever 15 is pivotably attached about a pivoting joint 16 to the first section 2. The cylinder 13 of the second piston/cylinder unit 11 may also be pivotably attached to the first section 2 about a pivoting joint 36. Another pivoting joint 37 may be formed between the coupling rod 14 and the locking lever 15.

By displacing the coupling rod 14 or the piston 12 of the second piston/cylinder unit 11 interacting with the coupling rod 14, the locking lever 15 may be displaced about the pivoting joint 16. To lock the second section 3 to the first section 2, a second end of the locking lever 15 may engage around a locking bolt 17, which may be formed on the second section 3. As may be seen in FIG. 2, when the locking device 10 is unlocked, the locking lever 15 may be pivoted downwards compared to that depicted in FIG. 3 so that the second end of the locking lever 15 releases the locking bolt 17.

When the piston 12 of the second piston/cylinder unit 11 assumes a piston position that causes the second section 3 to be locked in the unfolded position (see FIG. 3), the piston has a defined distance from a cylinder base of the cylinder 13 of the second piston/cylinder unit 11.

In the piston position of the piston 12 of the second piston/cylinder unit 11 causing the second section 3 to be locked in the unfolded position, the piston 12 therefore does not travel to stop on the cylinder 13 or cylinder base of the cylinder 13 of the second piston/cylinder unit 11. This may make it possible to compensate for wear in the area of, for example, the locking device 10 or also the pivoting joint 5, and therefore may ensure secure locking of the second section 3 in the unfolded position on the first section 2, which, in turn, may prevent undesired relative movement between the first section 2 and the second section 3.

As previously explained, the first piston/cylinder unit 7, which interacts with the pivoting joint 5, is positioned on an opposite side of the transfer device 1, similar to the second piston/cylinder unit 11, which may be part of the locking device 10. This may ensure favorable lever ratios for locking the first section 2 and the second section 3 in the locking position. When the first section 2 and the second section 3 are locked, the locking lever 15 may cause the opposite or adjacent end regions thereof to be pressed against each other.

In one or some embodiments, the piston 8 of the first piston/cylinder unit 7 is extended from the cylinder 9 of the first piston/cylinder unit 7 to transfer the second section 3 into the unfolded position. This extension direction is visualized in FIG. 4 by an arrow 18. It follows from this that the piston 8 of the first piston/cylinder unit 7 is retracted into the cylinder 9 in the direction opposite that visualized by the arrow 18 in order to transfer the second section 3 into the folded position.

In one or some embodiments, the piston 12 of the second piston/cylinder unit 11 is retracted into the cylinder 13 of the second piston/cylinder unit 11 in the unfolded position in order to lock the second section 3 to the first section 2, wherein an arrow 19 visualizes this retraction direction in FIG. 4. It follows that to unlock the second section 3, the piston 12 of the second piston/cylinder unit 11 is extended from the cylinder 13 thereof in the direction opposite that visualized by the arrow 19.

In one or some embodiments, as may be seen from FIG. 4, both the first piston/cylinder unit 7 and the second piston/cylinder unit 11 are dual-acting. A first hydraulic chamber 20 of the cylinder 9 of the first piston/cylinder unit 7 and a second hydraulic chamber 21 of the cylinder 9 of the first piston/cylinder unit 7 are each coupled to a hydraulic reservoir 22 via a hydraulic line 23, 24 and a switching valve unit 27 having two switching valves 25, 26. If the piston 8 of the first piston/cylinder unit 7 is to be extended from the cylinder 9 in the direction of the arrow 18, hydraulic fluid is filled into the hydraulic chamber 20 from the hydraulic reservoir 22, and hydraulic fluid is discharged from the hydraulic chamber 21. The switching valves 25, 26 then may assume switching positions corresponding thereto. If the piston 8 of the first piston/cylinder unit 7 is to be retracted into the cylinder 9, hydraulic fluid may be supplied to the hydraulic chamber 21, and, conversely, hydraulic fluid may be discharged from the hydraulic chamber 20, wherein the switching valves 25, 26 again assuming corresponding switching positions. When the second section 3 has been transferred into the unfolded position relative to the first section 2 by extending the piston 8 from the cylinder 9 of the first piston/cylinder unit 7, which may be detected with the aid of a sensor 42, the second section 3 may then be locked to the first section 2 with the aid of the locking device 10, wherein to accomplish this, the piston 12 of the second piston/cylinder unit 11 may be retracted into the cylinder 13 thereof for this purpose. For example, the sensor 42 may generate sensor data indicative of the position of the second section. In practice, the sensor 42 may transmit (wired and/or wirelessly) the sensor data indicative of the position of the second section to the control unit 38. In turn, the control unit 38 may analyze the sensor data indicative of the position of the second section (such as comparing the sensor data with predetermined stored data in memory 40) in order to determine whether the second section is in the unfolded position. Responsive to the control unit 38 determining that the second section is in the unfolded position, the control unit 38 may send a command to the locking device 10 In this regard, a control unit 38 may be configured to: receive input(s) from various device(s), such as wired and/or wirelessly 43 from a touchscreen 41 (or the like that may be resident in the cabin of the agricultural harvesting machine 44) and/or sensor 42; and/or generate output(s) for one or more devices (e.g., send commands to first piston/cylinder unit 7 and/or second piston/cylinder unit 11). In this regard, any devices disclosed herein may communicate with control unit 38 via wired and/or wirelessly 43.

In this way, the control unit 38 may be in communication with the sensor, and may be configured to control the transfer device based on data generated by the sensor. For example, the sensor may be configured to generate data indicative of a position of the second section (e.g., in the folded position and/or in the unfolded position). Further, the control unit may be configured to determine, based on the data generated by the sensor, how to control the second section (e.g., the control unit may determine, based on the data from the sensor being indicative of the second section being in the unfolded position, to control the locking device, such as by controlling the piston of the second piston/cylinder unit to retract into the cylinder of the second piston/cylinder unit).

In one or some embodiments, control unit 38 may comprise at least one processor 39, such as a microprocessor, controller, PLA, or the like and at least one memory 40, such as any type of storage device. Though the processor 39 and the memory 40 are depicted as separate elements, they may be part of a single machine, which includes a microprocessor (or other type of controller) and a memory. Alternatively, the processor 39 may rely on the memory 40 for all of its memory needs. In one or some embodiments, the memory 40 may comprise a tangible computer readable storage medium that stores a computer program comprising instructions which, when the instructions are executed by the processor 39, cause the control unit 38 to perform any one, any combination, or all of the functions described herein by the control unit 38.

The processor 39 and the memory 40 are merely one example of a computational configuration. Other types of computational configurations are contemplated. For example, all or parts of the implementations may be circuitry that includes a type of controller, including an instruction processor, such as a Central Processing Unit (CPU), microcontroller, or a microprocessor; or as an Application Specific Integrated Circuit (ASIC), Programmable Logic Device (PLD), or Field Programmable Gate Array (FPGA); or as circuitry that includes discrete logic or other circuit components, including analog circuit components, digital circuit components or both; or any combination thereof. The circuitry may include discrete interconnected hardware components or may be combined on a single integrated circuit die, distributed among multiple integrated circuit dies, or implemented in a Multiple Chip Module (MCM) of multiple integrated circuit dies in a common package, as examples.

As one example, control unit 38 may receive input from an operator via touchscreen 41 in order to control transfer device 1 (e.g., to transfer the second section 3 into the folded position and/or to transfer the second section 3 into the unfolded position). Responsive to receive of the input, the control unit 38 may be configured to send one or more commands in order to effect the desired input. Merely by way of example, responsive to input requesting that the second section 3 be transferred into the unfolded position relative to the first section 2, the control unit 38 may be configured to command the piston 8 from the cylinder 9 of the first piston/cylinder unit 7 to extend so that the second section 3 is transferred into the unfolded position relative to the first section 2. Responsive to sending this command, the control unit 38 may receive data input from sensor 42 in order to detect whether the second section 3 has been transferred into the unfolded position relative to the first section 2. Responsive to the control unit 38 detecting that the second section 3 has been transferred into the unfolded position relative to the first section 2, the control unit 38 may send command(s) to lock the second section 3 (e.g., the control unit 38 may send command(s) to the second piston/cylinder unit 11 in order to retract the piston 12 into the cylinder 13). Thus, control unit 38 may be configured to control one or more aspects of the transfer device 1.

According to FIG. 4, the second piston/cylinder unit 11 is also dual-acting, wherein hydraulic chambers 28, 29 of the cylinder 13 of the second piston/cylinder unit 11 are coupled to the hydraulic lines 23, 24 via other hydraulic lines 30, 31 and another switching valve 32. Therefore, the hydraulic chamber 29 of the cylinder 13 of the second piston/cylinder unit 11 which may be filled with hydraulic fluid to retract the piston 12 thereof (e.g., under command by the control unit 38) and therefore to lock the locking device 10, is coupled via the hydraulic line 30 to the hydraulic line 23 through which hydraulic fluid is supplied to the hydraulic chamber 20 of the cylinder 9 of the first piston/cylinder unit 7 to extend the piston 8 from the cylinder 9 when the second section 3 is transferred into the unfolded position.

The other hydraulic chamber 28 of the cylinder 13 of the second piston/cylinder unit 11 from which hydraulic fluid is discharged when the locking device is locked, is coupled via the intermediate switching valve 32 to the hydraulic line 24, which, in turn, may be connected to the hydraulic chamber 21 of the cylinder 9 of the first piston/cylinder unit 7.

Responsive to sensor 42 generating data that the control unit 38 may use to detect that the piston 8 has been extended from the cylinder 9 of the first piston/cylinder unit 7 or that the second section 3 has been transferred to the unfolded position, the switching valve 32 may then be switched, and the piston 12 of the second piston/cylinder unit 11 may be retracted in order to lock the locking device 10 and therefore lock the second section 3 to the first section 2 of the transfer device 1 (e.g., the control unit 38, responsive to detecting that the piston 8 has been extended from the cylinder 9 of the first piston/cylinder unit 7 or that the second section 3 has been transferred to the unfolded position, may send one or more commands to the switching valve 32 to switch, and to the piston 12 of the second piston/cylinder unit 11 to retract in order to lock the locking device 10).

According to FIG. 4, check valves 33, 34 of a valve unit 35 are connected in the hydraulic lines 23 and 24 between the switching valves 25 and 26 and the branch points of the hydraulic lines 30, 31, wherein the check valves 33, 34 are interconnected with each other in such a way that only one of these check valves 33, 34 blocks the flow in the blocking direction of the respective check valve 33, 34. In this regard, control unit 38 may be configured to control check valves 33, 34 accordingly in order to control the transfer device 1 accordingly.

Further, it is intended that the foregoing detailed description be understood as an illustration of selected forms that the invention may take and not as a definition of the invention. It is only the following claims, including all equivalents, that are intended to define the scope of the claimed invention. Further, it should be noted that any aspect of any of the preferred embodiments described herein may be used alone or in combination with one another. Finally, persons skilled in the art will readily recognize that in preferred implementation, some, or all of the steps in the disclosed method are performed using a computer so that the methodology is computer implemented. In such cases, the resulting physical properties model may be downloaded or saved to computer storage.

### LIST OF REFERENCE NUMBERS

1 Transfer device
2 First section
3 Second section
4 Pivot axis
5 Pivoting joint
6 Coupling rod
7 First piston/cylinder unit
8 Piston
9 Cylinder
10 Locking device
111 Second piston/cylinder unit
12 Piston
13 Cylinder
14 Coupling rod
15 Locking lever
16 Pivoting joint
17 Locking bolt
18 Approaching direction
19 Retraction direction
20 Hydraulic chamber
21 Hydraulic chamber
22 Hydraulic reservoir
23 Hydraulic line
24 Hydraulic line
25 Switching valve
26 Switching valve
27 Valve unit
28 Hydraulic chamber
29 Hydraulic chamber
30 Hydraulic line
31 Hydraulic line
32 Switching valve
33 Check valve
34 Check valve
35 Valve unit
36 Pivoting joint
37 Pivoting joint
38 Control unit
39 Processor
40 Memory
41 Touchscreen
42 Sensor
43 Wireless communication
44 Agricultural harvesting machine

1. An agricultural harvesting machine comprising:
a transfer device having a first section and a second section, the second section configured to pivot about a pivot axis relative to the first section between an unfolded position in which the second section extends as a longitudinal extension of the first section and a folded position in which the second section is positioned alongside the first section;
a first piston/cylinder unit configured to drive a pivoting movement of the second section relative to the first section between the folded position and the unfolded position; and
a locking device having a second piston/cylinder unit configured to lock the second section to the first section in the unfolded position, the second piston/cylinder unit comprising a piston and a cylinder;
wherein the piston of the second piston/cylinder unit, when positioned in a piston position, has a defined distance from a cylinder base of the cylinder of the second piston/cylinder unit, thereby causing the second section to lock in the unfolded position.

2. The agricultural harvesting machine of claim 1, wherein the piston of the second piston/cylinder unit, in the piston position so that the second section locks in the unfolded position, does not travel to stop on the cylinder.

3. The agricultural harvesting machine of claim 1, wherein the first piston/cylinder unit is positioned on a first side of the transfer device on which the pivot axis is formed; and
wherein the second piston/cylinder unit is positioned on a second side of the transfer device.

4. The agricultural harvesting machine of claim 3, wherein the second side of the transfer device is opposite the first side of the transfer device.

5. The agricultural harvesting machine of claim 4, wherein the locking device has a locking lever positioned on the second side of the transfer device, which interacts with at least a part of the piston of the second piston/cylinder unit.

6. The agricultural harvesting machine of claim 5, wherein the locking lever is configured to interact with the piston of the second piston/cylinder unit so that the locking lever presses at least a part of the first section and the second section with each other when the second section is locked to the first section.

7. The agricultural harvesting machine of claim 6, wherein the locking lever is configured to press end regions of the first section and the second section against each other when the second section is locked to the first section.

8. The agricultural harvesting machine of claim 1, wherein the piston of the first piston/cylinder unit is configured to extend from the cylinder of the first piston/cylinder unit to transfer the second section into the unfolded position.

9. The agricultural harvesting machine of claim 8, wherein the piston of the second piston/cylinder unit is configured to move into the cylinder of the second piston/cylinder unit to lock the second section in the unfolded position.

10. The agricultural harvesting machine of claim 9, wherein the piston of the first piston/cylinder unit is configured to move into the cylinder of the first piston/cylinder unit in order to transfer the second section into the folded position.

11. The agricultural harvesting machine of claim 10, wherein the piston of the first piston/cylinder unit is configured to extend out of the cylinder of the second piston/cylinder unit in order to unlock the second section.

12. The agricultural harvesting machine of claim 11, wherein the first piston/cylinder unit is dual-acting; and
wherein a first hydraulic chamber and second hydraulic chamber of the cylinder of the first piston/cylinder unit is coupled, respectively, to a hydraulic reservoir via a first hydraulic line and a second hydraulic line, and via a first switching valve and a second switching valve.

13. The agricultural harvesting machine of claim 12, wherein the second piston/cylinder unit is dual-acting;
wherein a first hydraulic chamber of the cylinder of the second piston/cylinder unit is coupled to the first hydraulic line via a first respective hydraulic line; and
wherein a second hydraulic chamber of the cylinder of the second piston/cylinder unit is coupled to the second hydraulic line via a second respective hydraulic line and a switching valve.

14. The agricultural harvesting machine of claim 1, further comprising a control unit and a sensor in communication with the control unit; and
wherein the control unit is configured to control the transfer device based on data generated by the sensor.

15. The agricultural harvesting machine of claim 14, wherein the sensor is configured to generate data indicative of a position of the second section; and
wherein the control unit is configured to determine, based on the data generated by the sensor, how to control the second section.

16. The agricultural harvesting machine of claim 15, the data is indicative of the second section is in the unfolded position; and
wherein the control unit is configured to determine, based on the data generated by the sensor, whether the second section is in the unfolded position.

17. The agricultural harvesting machine of claim 16, wherein the control unit, responsive to determining that the second section is in the unfolded position, is configured to control the locking device.

18. The agricultural harvesting machine of claim 17, wherein the control unit, responsive to determining that the second section is in the unfolded position, is configured to control the piston of the second piston/cylinder unit to retract into the cylinder of the second piston/cylinder unit.
